(19) United States
(12) Patent Application Publication
(10) Pub. No.: US 2004/0022894 A1
(43) Pub. Date: Feb. 5, 2004

(54) Molding machine closing apparatus having movable platen both guided and driven by multiple actuators

(76) Inventor: Jong Hwan Kim, Kwangmyung City (KR)

Correspondence Address: John R. Flanagan, Flanagan & Flanagan, P.O. Box 2629, Eugene, OR, 97402, US

(21) Appl. No.: 10/209,985

(22) Filed: Jul. 31, 2002

(51) Int. Cl. B29C 45/66

(52) U.S. Cl. 425/589

(57) ABSTRACT

A molding machine closing apparatus has a plurality of actuators for moving and guiding a movable platen toward and away from a stationary platen and having respective cylinders mounted to the movable platen and extending therefrom away from the stationary platen and respective piston rods extending from the cylinders through passages in the movable platen toward the stationary platen to where the piston rods are connected to the stationary platen. Selected actuation of the actuators will either retract them so as to cause the movable platen to move toward the stationary platen closing the second mold part with the first mold part or expand them so as to cause the movable platen to move away from the stationary platen displacing the second mold part from the first mold part.

### BACKGROUND OF THE INVENTION

1. Field of the Invention

The present invention generally relates to machines (hereinafter, for the sake of brevity, referred to as “molding” machines) for injection molding or die casting of articles and, more particularly, is concerned with a closing apparatus for such molding machine having a movable platen, supporting one mold part, being both guided and driven by multiple retractable and expandable actuators toward and away from a fixed platen, supporting another mold part.

2. Description of the Prior Art

A closing apparatus of a common type of prior art molding machine, for example as disclosed in each of U.S. Pat. No. 4,088,432 to Farrell, U.S. Pat. No. 4,566,522 to Fink et al., U.S. Pat. No. 4,592,407 to Yamaguchi et al., U.S. Pat. No. 4,685,876 to Loscei, and U.S. Pat. No. 5,252,286 to Bugatti, typically includes spaced-apart stationary rear and front platens (sometimes also referred to as stationary walls or tables), a movable middle platen (sometimes also referred to as a movable wall or table) interposed between the stationary rear and front platens, a plurality of equally-spaced and horizontally-disposed parallel tie bars (usually four in number) extending between and interconnecting the stationary platens and holding them in a fixed relationship with one another while the movable middle platen is slidably mounted on the tie bars for reciprocating movement relative to the stationary platens, a toggle mechanism extending between and pivotally interconnecting the stationary rear platen and the movable middle platen, and a hydraulic actuator or other mechanism for advancing and retracting the toggle mechanism to move the movable middle platen toward and away from the stationary front platen and thereby correspondingly close and open respective mold parts supported at facing sides of the movable middle platen and stationary front platen.

This molding machine closing apparatus has several problems. First, it has a large number of parts which require periodic maintenance, in terms of adjustment and/or replacement, which translate into high operating costs. Second, the large number of parts increases the mass of and space occupied by the apparatus which also translates into higher investment costs and lower productive capacity of the machine. Third, the inherent mode of operation of the toggle mechanism limits the range of adjustability of the stroke of movement of the movable platen toward and away from the stationary front platen and thereby the range of sizes of the articles which can be produced by the mold parts supported by these platens. Fourth, the large number of parts make the operation of the closing apparatus more complicated requiring greater attention and skill on the part of the operator.

Consequently, a need still exists for innovations with respect to this prior art molding machine closing apparatus which will solve the cited problems without introducing any new problems in place thereof.

### SUMMARY OF THE INVENTION

The present invention provides a molding machine closing apparatus designed to satisfy the aforementioned need. The molding machine closing apparatus of the present invention overcomes the cited problems by eliminating the stationary rear platen, the plurality of tie rods, the toggle mechanism and the hydraulic actuator used to drive the toggle mechanism and by substituting in place thereof a plurality of hydraulic actuators which both guide and drive the movable platen with respect to the stationary front platen. The reduction in the reduction in the size and number of parts of the closing apparatus reduces the overall cost of the molding machine and also its periodic maintenance costs. The complexity of the machine is also reduced which allows persons with less skill to operate the molding machine. Also, the space occupied by the molding machine is reduced which increases the range of adjustability of the stroke of movement of the movable platen toward and away from the stationary front platen and thereby increases the range of sizes of the articles which can be produced by the molding machine.

Accordingly, the present invention is directed to a closing apparatus for a molding machine. The closing apparatus comprises: (a) a stationary platen having oppositely-facing front and rear sides and being adapted for mounting a first mold part on the front side; (b) a movable platen having oppositely-facing front and rear sides and being adapted for mounting a second mold part on said front side; and (c) a plurality of actuators disposed for both moving and guiding the movable platen toward and away from the stationary platen, each of the actuators having a cylinder and a piston rod telescopably and slidably movable relative to one another, the cylinders having respective front ends fixedly mounted to the rear side of the movable platen such that the cylinders extend away from the rear side of the movable platen to rear ends of the cylinders spaced remote from the movable platen, the piston rods having respective front and rear ends and pistons proximate the rear ends and disposed in the cylinders such that the pistons are movable between the front and rear ends of the cylinders with the piston rods extending from the front ends of the cylinders through passages formed in the movable platen and beyond the front side of the movable platen toward the rear side of the stationary platen to where the front ends of the piston rods are fixedly connected to the stationary platen such that selected actuation of the actuators will either retract the actuators such that the cylinders move in a first direction relative to the piston rods that causes the actuators to decrease in length and the movable platen to be moved toward the stationary platen and thereby displace the second mold part to a closed relationship with the first mold part or expand the actuators such that the cylinders move in a second direction relative to the piston rods opposite to the first direction that causes the actuators to increase in length and the movable platen to be moved away from the stationary platen and thereby displace the second mold part to an opened relationship with the first mold part.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is a perspective view of a molding machine closing apparatus of the present invention shown in an opened condition and having some portions shown in sectional form.

FIG. 2 is a schematic view of an arrangement of components of the closing apparatus that sense movement of a movable platen of the closing apparatus and that supply fluid for controlling actuation of actuators of the closing apparatus.

FIG. 3 is a side elevational view of the closing apparatus of FIG. 1 shown in a closed condition and having some portions shown in sectional form.

FIGS. 4A and 4B taken together constitute an exploded view of the closing apparatus of FIG. 3.

### DETAILED DESCRIPTION OF THE INVENTION

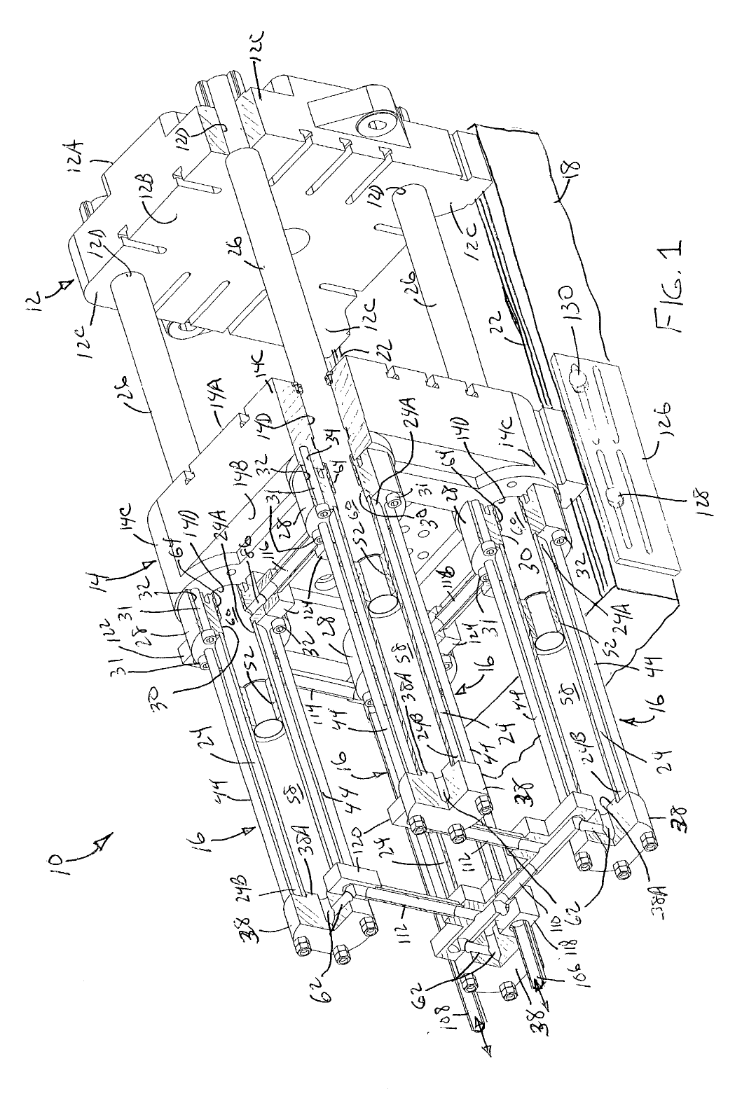

Referring to the drawings and particularly to FIGS. 1-3, there is illustrated a closing apparatus, generally designated 10, of a molding machine. The closing apparatus 10, which comprises the present invention, basically includes stationary and movable platens 12, 14 and a plurality of actuators 16 disposed for both moving and guiding the movable platen 14 toward and away from the stationary platen 12. Since injection and molding mechanisms of the molding machine are conventionally well-known and form no part of the present invention, those mechanisms need not be shown in the drawings nor described herein for one of ordinary skill in the art to gain a thorough and complete understanding of the closing apparatus 10 of the present invention.

The stationary platen 12 of the apparatus 10 has oppositely-facing front and rear sides 12A, 12B and is adapted to mount a first mold part 18 on the front side 12A. The stationary platen 12, in turn, is mounted by well-known elements, such as brackets and fasteners (not shown), in a fixed upright position on a conventional support base 18 of the molding machine. The stationary platen 12, preferably, has a generally rectangular configuration with four spaced apart peripherally-located corners 12C thereon and four bores 12D defined therethrough such that each of the bores 12D is disposed at one of the corners 12C. Alternatively, the stationary platen 12 could have other configurations, one being a triangular configuration with three corners thereon and three bores defined therethrough and disposed at the corners.

The movable platen 14 of the apparatus 10 has oppositely-facing front and rear sides 14A, 14B and is adapted to mount a second mold part 20 on the front side 14A which is mateable in a closed relationship with the first mold part 18 on the stationary platen 12. The movable platen 14, in turn, is mounted by well-known elements, such as rollers or the like (not shown) located beneath the movable platen 14 and a pair of generally horizontal and parallel guide tracks 22 formed on the support base 18, in an upright position on the support base 18 and so as to undergo movement along the support base 18 toward and away from the stationary platen 12. The movable platen 14, preferably, has a generally rectangular configuration with four spaced apart peripherally-located corners 14C thereon and passages 14D defined therethrough such that each of the passages 14D is disposed at one of the corners 14C. Alternatively, the movable platen 14 could have other configurations, one being a generally triangular configuration with three corners thereon and three passages defined therethrough at the corners.

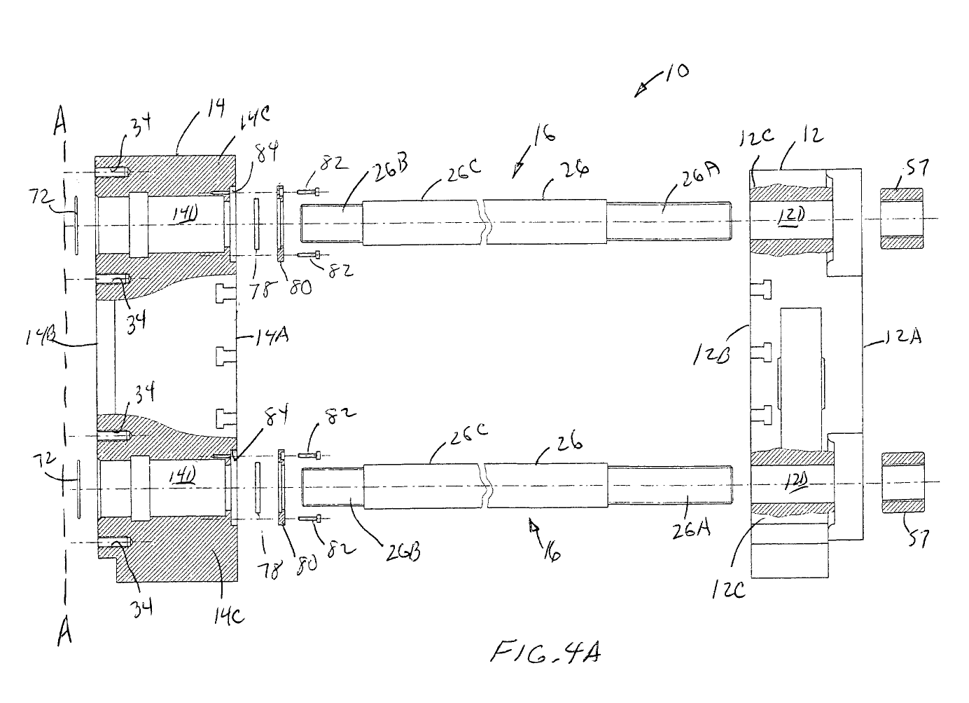

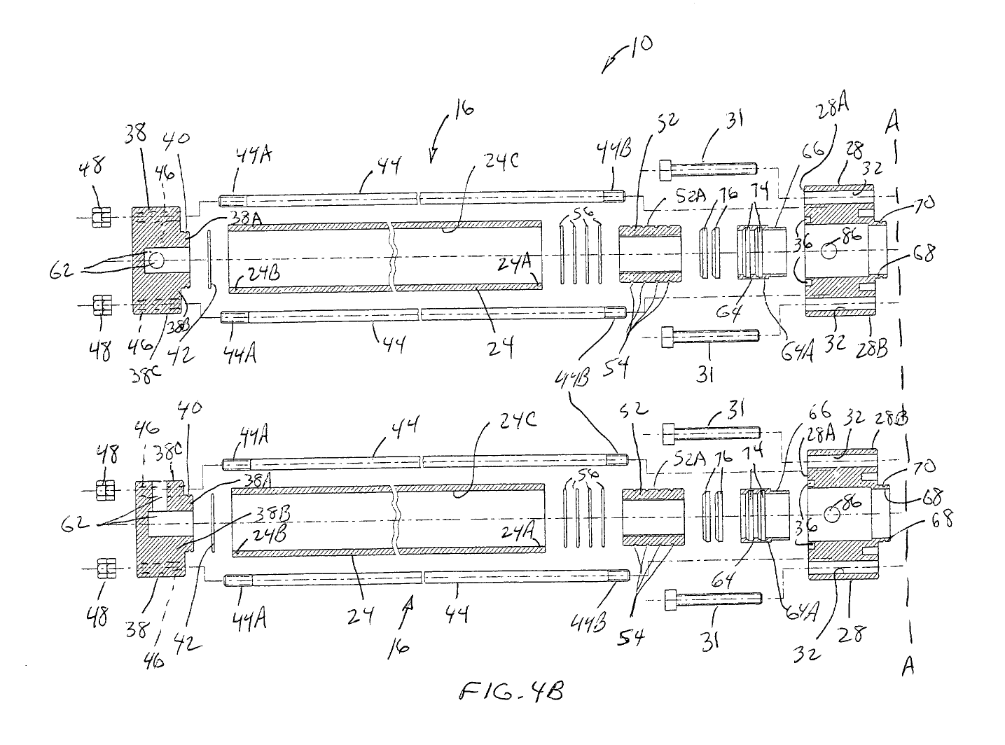

Referring now to FIGS. 1, 3, 4A and 4B, each actuator 16 of the apparatus 10 has an elongated cylinder 24 and an elongated piston rod 26 telescopably and slidably movable relative to one another. Each of the cylinders 24 of the actuators 16 has respective front and rear ends 24A, 24B and is cylindrical in configuration. The actuators 16 have respective cylinder heads 28 with central openings 30 defined therethrough. The respective heads 28 are secured to the corners 14C of the movable platen 14 at the rear side 14B thereof by a plurality of fastener bolts 31 inserted through apertures 32 defined in the heads 28 at locations spaced about the central opening 30 such that the latter are aligned with the passages 14D through the movable platen 14. The fastener bolts 31 are threaded into threaded holes 34 which are defined in the rear side 14B of the movable platen 14 about the passages 14D. The respective front ends 24A of the cylinders 24 are seated in annular grooves 36 defined in the rear ends 28A of the heads 28 between the central openings 30 and apertures 32 thereof such that the heads 28 are thereby mounted between the front ends 24A of the cylinders 24 and the rear side 14B of the movable platen 14. Also, the actuators have respective cylinder covers 38 with annular shoulders 38A defined on front ends 38B of the covers 38 which protrude into and mate with the rear ends 24B of the cylinders 24 so as to close the same. Each cover 38 has an annular groove 40 formed about its respective annular shoulder 38A and an O-ring 42 is seated in the annular groove 40 so as to form a seal with the rear end 24B of the respective cylinder 24 received over the annular shoulder 38A.

Each actuator 16 also include a plurality of connection bolts 44 associated with each respective cylinder 24 so as to extend between and interconnect the cover 38 to the heads 28 so as to retain the respective cylinder 24 between the head 28 and cover 38. More particularly, threaded rear ends 44A of the connection bolts 44 extend through apertures 46 defined through the cover 38 and have nuts 48 tightened thereon to fasten the cover 38 on the rear end 24B of the respective cylinder 24. Threaded front ends 44B of the connection bolts 44 are screwed into threaded apertures 50 which are tapped in the rear end 28A of the head 28 in spaced apart relationship to one another about the central opening 30. Thus, in such manner the respective cylinders 24 are fixedly mounted to the rear side 14B of the movable platen 14 such that the cylinders 24 extend rearwardly away therefrom.

Each of the piston rods 26 of the actuators 16 is of a cylindrical configuration and has respective front and rear ends 26A, 26B of reduced diameter compared to the remainder of the piston rod extending between its front and rear ends 26A, 26B. Also, each piston rod 26 has a piston 52 installed over the rear end 26B of the piston rod 26. The piston rod 26 and piston 52 of each actuator 16 are disposed in the respective cylinder 24 such that the piston 52 is movable between the front and rear ends 24A, 24B of the cylinder 24 with the piston rod 26 extending from the front end 24A of the cylinder 24 through one of the passages 14D formed in the movable platen 14 and beyond the front side 14A of the movable platen 14 toward the rear side 12B of the stationary platen 12 to where the front end 26A of the piston rod 26 is fixedly connected to the stationary platen 12. Each piston 52 has a plurality of spaced apart annular grooves 54 defined about its exterior surface 52A and O-rings 56 seated in the annular grooves 54 so as to form a sliding seal between the piston 52 and the interior wall 24C of the respective cylinder 24. The front end 26A of each piston rod 26 is threaded and extends through one of the bores 12D of the stationary platen 12 and has a nut 57 threaded thereon so as to secure the front end 26A of the piston rod 26 to the stationary platen 12.

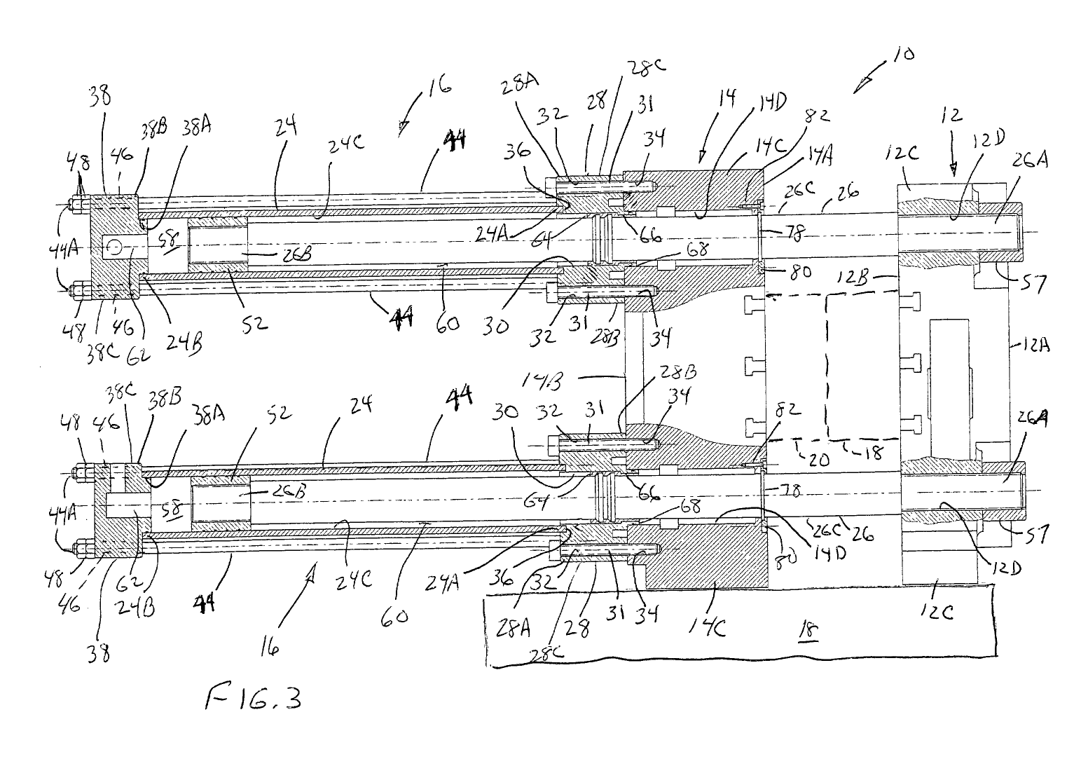

Furthermore, the actuators 16 have respective rear and front chambers 58, 60 formed in the cylinders 24 respectively rearwardly and forwardly of the pistons 52. The rear chamber 58 of each actuator 16 is formed in the respective cylinder 24 between the piston 52 of the respective piston rod 26 and the respective cover 38 on the rear end 24B of the respective cylinder 24. Also, each respective cover 38 has an right-angle shaped orifice 62 defined therein extending axially from the front end 38B through the annular shoulder 38A and then transversely to a peripheral surface 38C of the cover 38 thereof. The orifice 62 provides communication between the rear chamber 58 and the exterior of the cylinder 24. As will be described hereinafter, a suitable fluid, such as a hydraulic fluid, from a suitable source located exteriorly of the actuators 16 is injected into and withdrawn from the rear chamber 58 of each of the cylinders 24 via the orifice 62 for driving the actuators 16 between expanded and retracted conditions, as respectively shown in FIGS. 1 and 3.

The front chamber 60 of each actuator 16 is formed in the respective cylinder 24 between the piston 52 of the respective piston rod 26 and an annular bushing 64 disposed about the respective piston rod 26 and stationarily located at the rear side 14B of the movable platen 14 at a rear end of one of the passages 14D through the movable platen 14 and near the front end 24A of the respective cylinder 24. Each bushing 64 has an annular recess 66 formed about its front end 64A which receives an annular flange 68 attached to and protruding forwardly from a front end 28B of the respective head 28 on the front end 24A of the respective cylinder 24. The annular flange 68 on the respective head 28 extends into the rear end of the respective passage 14D of the movable platen 14 and has an annular groove 70 formed about the flange 68 and an O-ring 72 seated in the annular groove 70 so as to form a seal with the movable platen 14 at the rear end of the respective passage 14D therethrough. Each annular bushing 64 has a pair on annular grooves 74 formed into its interior surface and annular rubber packing elements 76 are seated in the grooves so as to form a sliding seal between the bushing 64 and the exterior surface 26C of the respective piston rod 26. Also, an annular seal packing 78 and cover 80 are fitted about each respective piston rod 26 and seated and secured by fasteners 82 within an annular recess 84 formed at the front end of one of the respective passages 14D of the movable platen 14. The seal packing 78 is employed for purposes of dust removal.

Further, each respective cylinder head 28 has an orifice 86 defined therein and extending radially outwardly from the central opening 30 of the head 28, at a location rearwardly of the bushing 64 positioned in the central opening 30, to an exterior surface 28C of the head 28. The orifice 86 of each respective head 28 provides flow communication between the front chamber 60 and the exterior of the cylinder 24. The fluid from the suitable source located exteriorly of the actuators 16 is injected into and withdrawn from the front chamber 60 of each cylinder 24 via the orifice 86 for driving the actuators 16 between retracted and expanded conditions, as respectively shown in FIGS. 3 and 1. Preferably, the actuators 16 are hydraulic actuators.

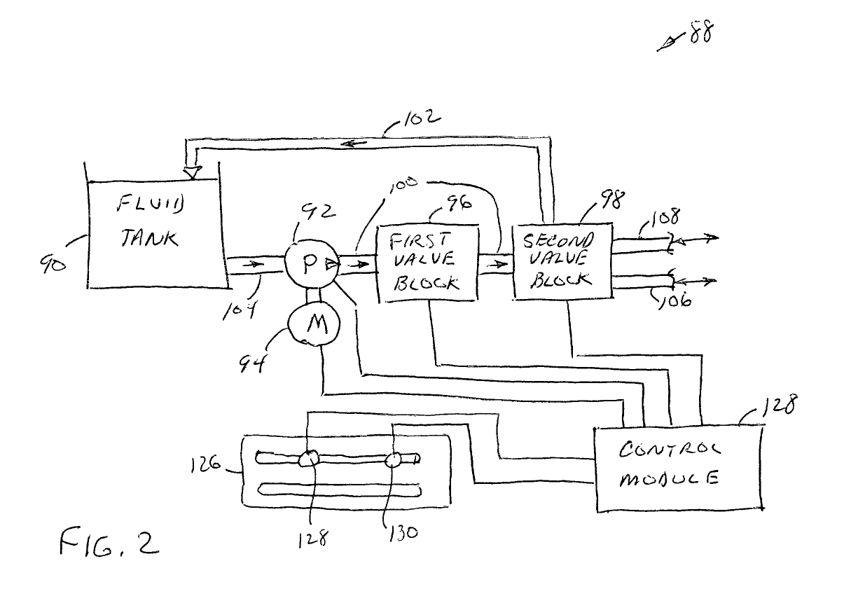

Referring to FIG. 2, there is also illustrated an arrangement 88 for carrying out selected actuation of the actuators 16 between their aforementioned retracted and expanded conditions. The arrangement 88, which does not constitute an element of the present invention, can take many forms. One exemplary form of the arrangement 88 is shown in FIG. 2. The exemplary arrangement 88 includes a fluid reservoir or tank 90, a pump 92 operated by a motor 94, first and second valve blocks 96, 98, a plurality of conduits 100-116 for transferring a suitable fluid, such as hydraulic oil between the fluid tank 90 and the rear and front chambers 58, 60 of the actuators 16. The first valve block 96 and second valve block 98 are serially connected in forward flow communication by a conduit 100 to a pressure outlet of the pump 92. The second valve block 98 is connected in reverse flow communication by another conduit 102 to the fluid tank 90. The fluid tank 90 is connected in forward flow communication by still another conduit 104 to a suction inlet of the pump 92. Conduit 106 interconnects the second valve block 98 in bi-directional flow communication with the rear chambers 58 of the respective cylinders 24 of the actuators 16 via respective interconnected branch conduits 110, 112, connector blocks 118, 120 and orifices 62 in cylinder covers 38. Conduit 108 interconnects the second valve block 98 in bi-directional flow communication with the front chambers 60 of the respective cylinders 24 of the actuators 16 via respective interconnected branch conduits 114, 116, connector blocks 122, 124 and orifices 86 in cylinder heads 28.

The arrangement 88 also includes a board 126 having limit switches 128, 130 for sensing the limits of the forward and rearward movement of the movable platen 14 and a control module 128 electrically connected between the pump 94 and first and second valve blocks 96, 98 for controlling their operations in response to the position of the movable platen 14 sensed by the limit switches 128, 130. The locations of the limit switches 128, 130 can be changed to accommodate different desired displacements of the movable platen 14 from the stationary platen 12.

The first and second valve blocks 96, 98, which per se have conventional constructions, are operated hydraulically by the electrical control module 128 so as to cause their respective valve sets (not shown) to be shifted laterally to control the direction of hydraulic fluid flow through the valve blocks 96, 98 in carrying out the selected actuation of the actuators 16 between their aforementioned retracted and expanded conditions. To move the second mold part 20, carried on the movable platen 14, into the closed relationship with the first mold part 18, supported on the stationary platen 12, so that articles can then be molded by the molding machine, the actuators 16 are actuated so as to cause retraction, or decrease, of their axial lengths. To retract the actuators 16, their cylinders 24 are moved relative to the stationary piston rods 26 in a first direction toward the stationary platen 12 which also causes the movable platen 14 to be moved with the cylinders 24 toward the stationary platen 12 and thereby displace the second mold part 20 to the closed relationship with the first mold part 18, as seen in FIG. 3. Conversely, to move the second mold part 20 into the opened relationship with the first mold part 18 so that the molded articles can then be removed from between the mold parts, the actuators 16 are actuated so as to cause expansion, or increase, of their axial lengths. To expand the actuators 16, their cylinders 24 are moved relative to the stationary piston rods 26 in a second direction, opposite the first direction, away from the stationary platen 12 which also causes the movable platen 14 to be moved with the cylinders 24 away from the stationary platen 12 and thereby displace the second mold part 20 to the opened relationship with the first mold part 18, as seen in FIG. 1. Portions of the hydraulic fluid are pumped or injected into and withdrawn from the rear chambers 58 of the cylinders 24 as other portions of the hydraulic fluid are withdrawn from and pumped or injected into the front chambers 60 of the cylinders 24 to correspondingly drive the actuators 16 between their retracted and expanded conditions.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. A molding machine closing apparatus, comprising:
(a) a stationary platen having oppositely-facing front and rear sides and being adapted for mounting a first mold part on said front side;
(b) a movable platen having oppositely-facing front and rear sides and being adapted for mounting a second mold part on said front side; and
(c) a plurality of actuators disposed for both moving and guiding said movable platen toward and away from said stationary platen, each of said actuators having a cylinder and a piston rod telescopably and slidably movable relative to one another, said cylinders having respective front ends fixedly mounted to said rear side of said movable platen such that said cylinders extend away from said rear side of said movable platen to rear ends of said cylinders spaced remote from said movable platen, said piston rods having respective front and rear ends and pistons proximate said rear ends and disposed in said cylinders such that said pistons are movable between said front and rear ends of said cylinders with said piston rods extending from said front ends of said cylinders through passages formed in said movable platen and beyond said front side of said movable platen toward said rear side of said stationary platen to where said front ends of said piston rods are fixedly connected to said stationary platen such that selected actuation of said actuators between retracted and expanded conditions will either retract said actuators such that said cylinders move in a first direction relative to said piston rods that causes said actuators to decrease in length and said movable platen to be moved toward said stationary platen and thereby displace the second mold part to a closed relationship with the first mold part or expand said actuators such that said cylinders move in a second direction relative to said piston rods opposite said first direction that causes said actuators to increase in length and said movable platen to be moved away from said stationary platen and thereby displace the second mold part to an opened relationship with the first mold part.

2. The apparatus of claim 1 wherein said actuators have respective rear chambers formed in said cylinders between said pistons of said piston rods and said rear ends of said cylinders such that a fluid can be injected into and withdrawn from said rear chambers for driving said actuators between said expanded and retracted conditions.

3. The apparatus of claim 2 wherein said actuators have respective cylinder covers mounted to and closing said rear ends of said cylinders and defining orifices that provide communication between said rear chambers and a source of fluid located exteriorly of said actuators.

4. The apparatus of claim 1 wherein said actuators have respective front chambers formed in said cylinders between said pistons of said piston rods and respective bushings disposed about said piston rods and stationarily located proximate said front ends of said cylinders such that a fluid can be injected into and withdrawn from said front chambers for driving said actuators between said retracted and expanded conditions.

5. The apparatus of claim 4 wherein said actuators have respective cylinder heads mounted between and interconnecting said front ends of said cylinders to said movable platen and defining orifices that provide communication between said front chambers and a source of fluid located exteriorly of said actuators.

6. The apparatus of claim 1 wherein said actuators have respective rear chambers formed in said cylinders between said pistons of said piston rods and said rear ends of said cylinders and respective front chambers formed in said cylinders between said pistons of said piston rods and respective bushings disposed about said piston rods and stationarily located proximate said front ends of said cylinders such that first portions of a fluid can be injected into and withdrawn from said rear chambers as second portions of the fluid are withdrawn from and injected into said front chambers to drive said actuators between said expanded and retracted conditions.

7. The apparatus of claim 6 wherein said actuators have respective cylinder covers mounted to and closing said rear ends of said cylinders and defining orifices that provide communication between said rear chambers and a source of fluid located exteriorly of said actuators.

8. The apparatus of claim 6 wherein said actuators have respective cylinder heads mounted between and interconnecting said front ends of said cylinders to said movable platen and defining orifices that provide communication between said front chambers and a source of fluid located exteriorly of said actuators.

9. The apparatus of claim 1 wherein said actuators have respective cylinder covers mounted to and closing said rear ends of said cylinders.

10. The apparatus of claim 9 wherein said cylinder covers have respective orifices that provide communication between said actuators and a source of fluid located exteriorly of said actuators.

11. The apparatus of claim 9 wherein said actuators have respective cylinder heads mounted between and interconnecting said front ends of said cylinders to said movable platen and pluralities of connection bolts that extend between and interconnect said cylinder covers to said cylinder heads so as to retain said cylinders between said respective cylinder covers and heads.

12. The apparatus of claim 11 wherein said cylinder heads have respective orifices that provide communication between said actuators and a source of fluid located exteriorly of said actuators.

13. The apparatus of claim 1 wherein said actuators are four in number.

14. The apparatus of claim 1 wherein said movable platen has a configuration providing at least three corners thereon, each of said passages being defined through said movable platen adjacent to one of said corners.

15. The apparatus of claim 1 wherein said movable platen has a generally rectangular configuration providing four corners thereon, each of said passages being defined through said movable platen adjacent to one of said corners.

16. The apparatus of claim 1 wherein said stationary platen has a plurality of bores defined therethrough which respectively receive said front ends of said piston rods.

17. The apparatus of claim 1 wherein said stationary platen has a configuration providing at least three corners thereon with at least three bores defined therethrough such that each of said bores is disposed adjacent to one of said corners and receives said front end of one of said piston rods.

18. The apparatus of claim 1 wherein said stationary platen has a generally rectangular configuration providing four corners thereon and four bores defined therethrough such that each of said bores is disposed adjacent to one of said corners and receives front end of one of said piston rods.

19. The apparatus of claim 1 wherein said stationary platen is adapted to be disposed upright on a support frame.

20. The apparatus of claim 19 wherein said movable platen is adapted to be disposed upright on a support frame and to undergo movement along the support frame toward and away from said stationary platen.
